(19) United States
(12) Patent Application Publication
(10) Pub. No.: US 2010/0072660 A1
(43) Pub. Date: Mar. 25, 2010

(54) LOW RELATIVE CRYSTALLINITY DIE DRAWING PROCESS FOR A CAVITATED FILLED ORIENTED POLYMER COMPOSITION

(76) Inventor: Felix Achille, Midland, MI (US)

Correspondence Address: The Dow Chemical Company, Intellectual Property Section, P.O. Box 1967, Midland, MI, 48641-1967, US

(21) Appl. No.: 12/527,511

(22) PCT Filed: Mar. 13, 2008
(86) PCT No.: PCT/US08/56788

§ 371 Date: Aug. 17, 2009

Related U.S. Application Data
(60) Provisional application No. 60/920,245, filed on Mar. 27, 2007.

(51) Int. Cl. B29C 47/88

(52) U.S. Cl. 264/211.12

(57) ABSTRACT

Drawing a filled polymer composition through a drawing die at a critical drawing temperature that is below the polymer composition's melting temperature yet above the polymer composition's crystallization temperature allows production of cavitated filled oriented polymer compositions by drawing from a low crystalline polymer state.

### BACKGROUND OF THE INVENTION

1. Field of the Invention

The present invention relates to a process for die drawing a filled polymer composition in order to induce cavitation and polymer orientation.

2. Description of Related Art

Oriented polymer compositions are desirable for having higher strength and stiffness over non-oriented polymer compositions. Historically, polymeric films and fibers have enjoyed the benefits of orientation through drawing processes. However, when a polymer cross section becomes larger than that of a film or fiber, drawing to a controlled and consistent shape becomes more complex and new drawing processes are necessary. Great Britain (GB) patent 1311885, for example, points out that a challenge with drawing large cross section billets is bringing the entire cross section to a uniform temperature prior to drawing in order to allow control of the extrusion velocity of the billet into the drawing die. Small cross section articles such as films and fibers do not present such a challenge.

GB1311885 discloses a solid state die drawing process to address the challenges of orienting larger cross section polymer compositions, which the patent identifies as compositions having a cross-sectional area of 0.01 square inches (6.45 square millimeters) or more or with all cross sectional dimensions greater than 0.05 inches (1.27 millimeters). The solid state die drawing process requires drawing a polymer composition billet through a lubricated drawing die in the polymer composition's solid phase at a temperature below the polymer composition's melting temperature (Tₘ). The drawing die forces the polymer composition to converge towards a specific shape, causing alignment of polymer chains. The polymer billet is melt formed and allowed to cool to room temperature (well below Tₘ for the polymer composition) to form a billet in the solid state. The polymer billet is then heated to a temperature below Tₘ to achieve a substantially uniform temperature prior to drawing. One of ordinary skill in the art understands that such a polymer billet advantageously has greater than 80%, more likely greater than 90% relative crystallinity in order to optimize tensile modulus of the final drawn polymer, which relies upon maximizing orientation of crystals in the polymer. (For teaching on aligning crystals for maximum modulus see, for example, U.S. Pat. No. 5,797,254 particularly at column 2, line 66 through column 3, line 3 and U.S. Pat. No. 4,053,270 particularly at column 1 lines 22-30; both patents incorporated herein by reference in their entirety).

It is often desirable to reduce the density of oriented polymer compositions by, for example, introducing void volume into the oriented polymer composition. One means of incorporating void volume into an oriented polymer composition is by cavitation. Cavitation is a phenomenon that can occur during solid state die drawing of a filled polymer composition or polymer of high relative crystallinity.

Cavitation occurs when die drawing a polymer composition to a sufficiently high actual draw ratio that polymer draws away from filler particles or crystals to create void spaces in the composition. Solid state drawing processes that achieve cavitation typically require: (1) extruding a molten polymer composition into billets, (2) cooling the billets to a solid state, (3) conditioning the billets back up to a drawing temperature that is below a melting temperature for the polymer composition, and then (4) drawing the billets, typically through a drawing die. For examples of such solid state drawing processes that induce cavitation see European Patent 1242220B1, U.S. Pat. No. 6,939,496 and US patent applications 2005/0171246 and 2005/0192382. As with the teachings of GB1311885, one of ordinary skill in the art would understand that the polymer billet in each of these references has a relative crystallinity of at least 80%, likely at least 90%, more likely closer to 100% as the polymer billet begins to draw.

Another process for manufacturing an oriented polymer composition with void volume is through the use of a blowing agent (“foaming agent” and “blowing agent” are interchangeable terms herein). U.S. Pat. No. 5,474,722 ('722) discloses one such process. '722 discloses both solid state and molten state polymer orientation processes. The molten state process offers efficiency advantages over the above-mentioned solid state drawing processes by enabling extrusion of a polymer composition directly from a molten state into a foamed and oriented polymer article. Such a molten state process obviates a need to cut extruded polymer compositions into individual billets, and/or to store the individual billets prior to die drawing, or to go through cooling and subsequent heating steps prior to die drawing.

The molten state process of '722 offers versatility over the above-mentioned solid state drawing processes by allowing a molten stream of polymer composition to collect in a reservoir after an extruder but prior to an orientation die. Use of such a reservoir allows for temperature conditioning of the polymer melt prior to die drawing and provides an ability to produce oriented polymer articles of larger cross section than the cross section of polymer expelled from an extruder. The molten state process of '722 realizes benefits by drawing in a molten state, but it requires a blowing agent to introduce void volume in order to adjust polymer density. The molten state processes demonstrated in '722 cannot achieve cavitation because the polymer is above Tₘ as it is drawn.

U.S. Pat. No. 4,948,545 ('545) offers a method for preparing an oriented polyolefin composition by extruding or drawing the composition through a die just above but not more than 7° C. above the polymer's self blocking temperature. In the method of '545 the polymer composition must contain a high weight-average molecular weight tail that exceeds one million grams per mole. The teachings are silent as to introduction of any void volume into the polymer composition by means of cavitation or foaming.

A process for producing filled oriented polymer compositions that enjoys at least one of the efficiency and/or versatility benefits associated with drawing a molten polymer composition as in the process of '722 yet that induces void volume into the polymer composition by cavitation as in high relative crystallinity solid state drawing processes would be a desirable advancement of the art.

### BRIEF SUMMARY OF THE INVENTION

The present invention solves the problems necessary to achieve a process for producing a filled oriented polymer composition that offers efficiency, versatility or both efficiency and versatility benefits similar to the '722 molten state process while introducing void volume through cavitation rather than blowing agent alone. Surprisingly, the process of the present invention is able to achieve cavitation without having the polymer composition in high relative crystalline state (that is, greater than 80% relative crystallinity) prior to drawing. As such, the present invention surprisingly and advantageously does not require heating the polymer composition to increase its temperature prior to drawing. In particular, the present invention surprisingly achieves cavitation upon drawing a polymer having less than 50% relative crystallinity and can even achieve cavitation upon drawing a polymer composition having a relative crystallinity as low as one percent.

The present invention is a process for producing a filled oriented polymer article comprising the steps: (a) blending at least one semi-crystalline thermoplastic polymer with a filler at a blending temperature to form a filled polymer composition having a melting temperature (Tₘ) and a crystallization temperature (T_{c}); (b) cooling the filled polymer composition at a cooling rate to a drawing temperature (T_{d}) without cooling below the filled polymer composition's T_{c}; (c) drawing the filled polymer composition through a drawing die at a drawing rate, thereby inducing polymer orientation and cavitation; and (d) cooling the filled polymer composition to a temperature below its T_{c} to form a cavitated filled oriented polymer article; wherein, the blending temperature is at or above the filled polymer composition's Tₘ, T_{d} is higher than the filled polymer composition's T_{c} yet lower than the temperature at which crystallization begins to occur as the filled polymer composition is cooled from above its Tₘ down to below its T_{c} at the cooling rate of step (b), and drawing in step (c) is initiated while the polymer composition has a relative crystallinity of 50% or less and one percent or more and while the polymer composition has a cross section that has a temperature at any point on the cross section within ten degrees Celsius from T_{d}.

Optionally, the present invention can further be characterized by one or any combination of the following characteristics: T_{d} is one to five degrees Celsius above T_{c} for the filled polymer composition; the drawing die in step (c) has a nominal draw ratio greater than 1:1; the drawing die has at least one semi-angle greater than one degree; the semi-crystalline thermoplastic polymer is one or a blend of more than one polymer selected from a group consisting of polymers based on polyethylene, polypropylene, polyvinyl chloride and polyester polymers; blowing agents are present at a concentration of less than three weight-percent based on total weight of filled polymer composition; the filled polymer composition in step (c) is free of blowing agents; the drawing die has an exit opening having a smallest cross sectional dimension greater than 1.5 millimeters; the drawing in step (c) is initiated while the polymer composition has a relative crystallinity of 20% or less, preferably 10% or less and one percent or more; and wherein the semi-crystalline polymers, preferably all polymers in the polymer composition are free from having a weight-averaged molecular weight component that is greater than one million grams per mole.

The process of the present invention is useful for producing cavitated, filled, oriented polymer compositions.

### BRIEF DESCRIPTION OF DRAWINGS

FIG. 1 illustrates a typical differential scanning calorimetry (DSC) curve for a semi-crystalline polymer showing both heating through the melting temperature (Tₘ) and cooling through the crystallization temperature (T_{c}).

### DETAILED DESCRIPTION OF THE INVENTION

### Terms

“ASTM” refers to American Society for Testing and Materials. ASTM test methods herein refer to the test method of the year the test method identifies as a suffix in the method number or, in an absence of such a suffice, the test method most current at the time of filing this application.

“Solid state” refers to a polymer (or polymer composition) that is below the softening temperature of the polymer (or polymer composition). Hence, “solid state drawing” refers to drawing a polymer or polymer composition that is below the softening temperature of the polymer (or polymer composition).

“Polymer composition” comprises at least one polymer component and can contain non-polymeric components.

“Softening temperature” (Tₛ) for a polymer or polymer composition having as polymer components only one or more than one semi-crystalline polymer is the melting temperature for the polymer composition.

“Melting temperature” (Tₘ) for a semi-crystalline polymer is the temperature half-way through a crystalline-to-melt phase change as determined by differential scanning calorimetry (DSC) upon heating a crystallized polymer at a specific heating rate. Determine Tₘ for a semi-crystalline polymer according to the DSC procedure in ASTM method E794-06. Determine Tₘ for a combination of polymers and for a filled polymer composition also by DSC under the same test conditions in ASTM method E794-06. If the combination of polymers or filled polymer composition only contains miscible polymers and only one crystalline-to-melt phase change is evident in the DSC curve, then Tₘ for the polymer combination or filled polymer composition is the temperature half-way through the phase change. If multiple crystalline-to-melt phase changes are evident in a DSC curve due to the presence of immiscible polymers, then Tₘ for the polymer combination or filled polymer composition is the Tₘ of the continuous phase polymer. If more than one polymer is continuous and they are not miscible, then the Tₘ for the polymer combination or filled polymer composition is the highest Tₘ of the continuous phase polymers.

Tₛ for a polymer or polymer composition having as polymer components only one or more than one amorphous polymer is the glass transition temperature for the polymer composition.

“Glass transition temperature” (T_{g}) for a polymer or polymer composition is the temperature half-way through a phase change as determined by DSC according to the procedure in ASTM method D3418-03. Determine T_{g} for a combination of polymers and for a filled polymer composition also by DSC under the same test conditions in D3418-03. If the combination of polymer or filled polymer composition only contains miscible polymers and only one glass transition phase change is evident in the DSC curve, then T_{g} for the polymer combination or filled polymer composition is the temperature half-way through the phase change. If multiple glass transition phase changes are evident in a DSC curve due to the presence of immiscible amorphous polymers, then T_{g} for the polymer combination or filled polymer composition is the T_{g} of the continuous phase polymer. If more than one amorphous polymer is continuous and they are not miscible, then the T_{g} for the polymer composition or filled polymer composition is the highest T_{g} of the continuous phase polymers.

If the polymer composition contains a combination of semi-crystalline and amorphous polymers, the softening temperature of the polymer composition is the softening temperature of the continuous phase polymer or polymer composition.

“Semi-crystalline polymer” refers to any thermoplastic polymer that demonstrates a melting temperature and crystallization temperature by differential scanning calorimetry (DSC) according to American Society for Testing and Materials (ASTM) method E794-06. Herein, reference to “semi-crystalline” polymers includes what are sometimes referred to as “crystalline” polymers.

A semi-crystalline polymer or polymer composition containing a semi-crystalline polymer “crystallizes” when it is cooled below the polymer's or polymer composition's crystallization temperature.

A semi-crystalline polymer or polymer composition is in a molten state upon heating above the polymer's or polymer composition's melting temperature and remains in a molten state until cooling below it crystallization temperature.

“Crystallization Temperature” (T_{c}) for a semi-crystalline polymer is the temperature half-way through a melt-to-crystalline phase change as determined by DSC upon cooling a molten polymer according at a specific cooling rate. In contrast, Tₘ is the temperature half-way through a crystalline-to-melt phase change determined by heating a polymer from a crystalline state to a molten state. Determine T_{c} for a semi-crystalline polymer according to the DSC procedure in ASTM method E794-06. Determine T_{c} for a combination of polymers and for a filled polymer composition also by DSC under the same test conditions in ASTM method E794-06. An artisan of ordinary skill recognizes that a DSC curve changes depending on the heating and/or cooling rate during data collection for the curve. While ASTM method E794-06 sets forth a procedure for measuring DSC curves, it is important to use a cooling rate equivalent to the cooling rate a polymer composition will experience prior to a drawing die as it approaches a drawing die in a process in which it will be drawn when determining T_{c} for the polymer composition.

If the filled polymer composition only contains miscible polymers and only one T_{c} is evident in the melt-to-crystalline phase change, then the T_{c} for the polymer combination or filled polymer composition is the temperature half-way through the phase change. If more than one T_{c} is evident from the melt-to-crystalline phase change in the DSC curve due to the presence of immiscible polymers, then T_{c} for the polymer combination or filled polymer composition is the T_{c} of the continuous phase polymer. If more than one polymer is continuous and they are not miscible, then the T_{c} for the polymer combination or filled polymer composition is the highest T_{c} of the continuous phase polymers.

“Drawing rate” refers to the linear rate at which a polymer composition exits a drawing die. Measure drawing rate in the drawing direction.

“Drawing direction” is the direction which a polymer composition is traveling during the drawing process.

“Cross section” of a polymer composition is in a plane perpendicular to the drawing direction of the polymer composition.

“Cross sectional dimension” is a dimension extending in a polymer composition's cross section and containing two points on the cross section's perimeter and containing the centroid of the cross section.

A polymer is “highly crystalline” and in a “highly crystalline state” and in a state of high crystallinity if it has a relative crystallinity of 80% or more. Such polymers typically have a relative crystallinity of 90% or more.

A polymer is in a “state of low crystallinity” and is a “low crystallinity” or “low crystalline” polymer if it has a relative crystallinity of 50% or less. A low crystallinity polymer can be 40% or less, 25% or less, 10% or less, 5% or less, or even one percent or less relative crystallinity.

“Relative crystallinity” is a measure of the level of crystallinity of a polymer composition divided by the maximum equilibrium level of crystallinity the polymer composition can achieve multiplied by 100%. Determine relative crystallinity by first recording an exothermic peak associated with crystallization of the polymer composition using DSC while cooling at a rate equivalent to the cooling rate the polymer composition experiences prior to the drawing die and as it approaches the drawing die when drawn in the present process. Integrate the area under the exothermic peak to determine the total Joules per gram under the entire exothermic peak. Second, determine exothermic energy released prior to the drawing temperature by measuring the Joules per gram under the exothermic peak only down to the temperature of the polymer composition as it enters the drawing die (the area at higher temperatures down to the drawing temperature). Divide exothermic energy released prior to the drawing temperature by the total Joules per gram under the entire exothermic peak and multiply by 100%.

“Drawing Die” is a structure having opposing ends and defining a shaping channel that extends entirely through the structure, from one end to the opposing end. The shaping channel serves as a conduit through the structure and through which a polymer composition travels. The shaping channel has an entrance opening on one end and an exit opening on the opposing end of the drawing die. Polymer composition enters the drawing die through the entrance opening and exits the drawing die through the exit opening. The entrance opening generally has a cross sectional area equal to the highest cross sectional area of the shaping channel. The exit opening generally has a cross sectional area equal to the smallest cross sectional area of the shaping channel.

The shaping channel has a centroid line that contains the centroid of each cross section of the shaping channel. A cross section lies in a plane perpendicular to the direction polymer composition travels through the centroid contained in the cross section and plane.

A typical drawing die has a shaping channel that reduces in cross sectional area between the entrance and exit opening. In such a drawing die, each side or, in the case of a conical shaping channel, each radial component converges towards the centroid line of the shaping channel by a “semi-angle” as one travels from the entrance opening to the exit opening. The semi-angle may be the same or different for different sides or radii in the shaping channel. The semi-angle may be the same or different for a given side or radius at different points along the centroid line of a shaping channel.

“Nominal draw ratio” of a drawing die is the ratio of the cross sectional area of the drawing die's entrance opening (or widest portion of the drawing die shaping channel) to the cross sectional area of the drawing die's exit opening. A drawing die's exit opening is the portion of shaping channel through which the filled polymer composition travels that has the smallest cross sectional area after the entrance opening. Cross sections lie in a plane perpendicular to the direction polymer travels through the cross section.

An artisan understands that a polymer composition typically has a variation in temperature through its cross section (that is, along a cross sectional dimension of the composition) during processing. Therefore, reference to temperature of a polymer composition refers to an average of the highest and lowest temperature along a cross sectional dimension of the polymer composition. The temperature at two different points along the polymer cross sectional dimension desirably differs by ten degrees Celsius (° C.) or less, preferably five ° C. or less, more preferably one ° C. or less, still more preferably 0.5° C. or less, and most preferably by 0° C. from the average temperature of the highest and lowest temperature along the cross sectional dimension. Measure the temperature in degrees Celsius (° C.) along a cross sectional dimension by inserting thermocouples to different points along the cross sectional dimension.

“Drawing temperature” (T_{d}) refers to the temperature of the polymer composition as it begins to undergo drawing in a solid state drawing die.

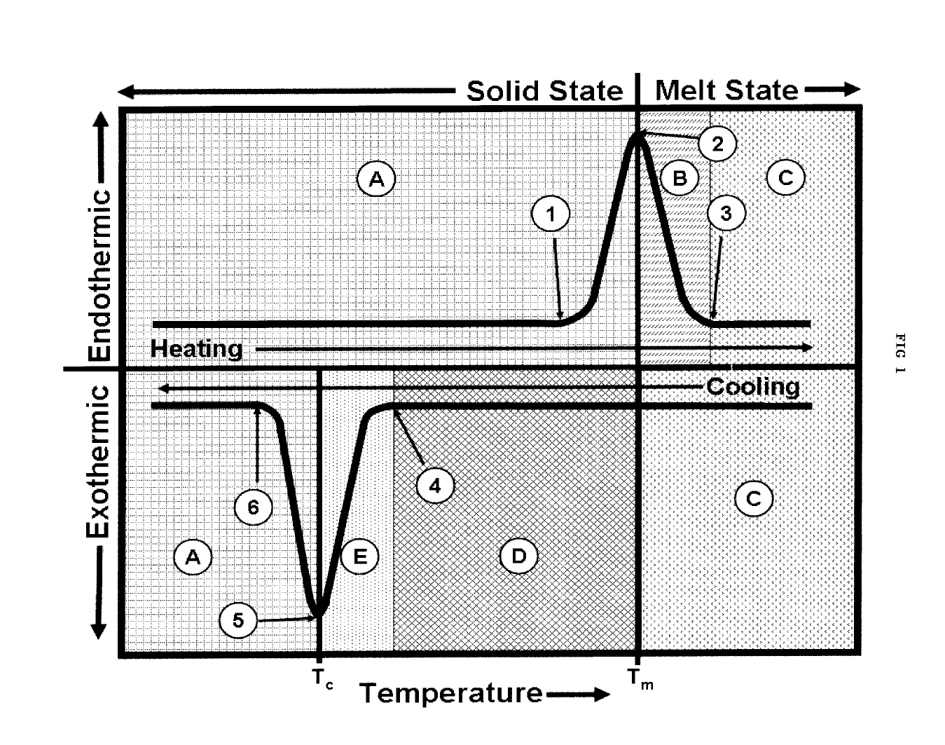

FIG. 1 illustrates some of the important polymer temperatures and polymer states for a semi-crystalline polymer composition relative to DSC curves. The top curve in FIG. 1 illustrates a typical DSC curve for a fully crystallized semi-crystalline polymer when heated from below to above its melt temperature (Tₘ). The bottom curve illustrates a typical DSC curve for a semi-crystalline polymer when cooled from above to below its crystallization temperature (T_{c}) to a fully crystallized state. Slowing the heating rate and cooling rate tend to bring Tₘ and T_{c} closer together, while speeding the heating rate and cooling rate tends to spread Tₘ and T_{c} further apart.

Temperature 1 in FIG. 1 illustrates the temperature at which the polymer composition first begins its melt transition (reducing its relative crystallinity) on heating.

Temperature 2 in FIG. 1 illustrates the Tₘ of the polymer composition.

Temperature 3 in FIG. 1 illustrates the temperature at which the polymer composition completes its melt transition upon heating and achieves zero percent relative crystallinity.

Temperature 4 in FIG. 1 illustrates the temperature at which the polymer composition first begins its crystallization transition thereby increasing relative crystallinity upon cooling.

Temperature 5 in FIG. 1 illustrates T_{c} for the polymer composition.

Temperature 6 in FIG. 1 illustrates the temperature at which the polymer composition completes its crystallization transition upon cooling.

Phase region A in FIG. 1 illustrates where the polymer composition is in a solid state with a high relative crystallinity (greater than 50% relative crystallinity).

Phase region B in FIG. 1 illustrates where the polymer composition is in a melt state, or molten state and yet has a medium to low relative crystallinity (greater than 0% to 50% relative crystallinity).

Phase region C in FIG. 1 illustrates where the polymer composition is in a melt state, or molten state that is non-crystalline (0% relative crystallinity).

Phase region D in FIG. 1 illustrates where the polymer composition is in a solid state since the temperature is below Tₘ, yet the polymer composition is in a non-crystalline state.

Phase region E illustrates where the polymer composition is in a solid state since its temperature is below Tₘ, yet the polymer composition is in a state of low relative crystallinity (greater than 0% to 50% relative crystallinity). This phase region defines the broadest temperature range for T_{d} in the present invention.

### Process

In the process of the present invention, form a filled polymer composition by blending at least one semi-crystalline thermoplastic polymer with a filler at a temperature equal to or higher than the melting temperature (Tₘ) of the filled polymer composition.

Any thermoplastic polymer that has a Tm is a suitable semi-crystalline thermoplastic polymer for use in the present process. For example, suitable semi-crystalline polymers include polymers based on polypropylene, polyethylene (for example, high density polyethylene), polymethylpentane, polytetrafluoroethylene, polyamides, polyesters (for example, polyethylene terephthalate), polyethylene oxide, polyoxymethylene, polyvinyl chloride, polyvinylidene fluoride polymers, and combinations thereof. Particularly desirable semi-crystalline polymers include polymers based on polyethylene, polypropylene, polyvinyl chloride or polyester polymers. A first polymer is “based on” a second polymer if the first polymer comprises the second polymer. For example, a block copolymer is based on the polymers comprising the blocks. Homopolymers are based on themselves.

Particularly useful semi-crystalline polymers for use in the present invention include polyolefin polymers (polyolefins). Linear polymers (that is, polymers in which chain branching occurs in less than 1 of 1,000 polymer units) are even more desirable.

Polypropylene (PP)-based polymers (that is, polymers based on PP) are desirable for use as semi-crystalline polymers in the present invention. PP-based polymers generally have a lower density than other semi-crystalline polyolefin polymers. Therefore, PP-based polymers facilitate lighter articles than other semi-crystalline polyolefin polymers.

Suitable PP-based polymers include Zeigler Natta, metallocene and post-metallocene polypropylenes. Suitable PP-based polymers include PP homopolymer; PP random copolymer (with ethylene or other alpha-olefin present from 0.1 to 15 percent by weight of monomers); PP impact copolymers with either PP homopolymer or PP random copolymer matrix of 50-97 percent by weight (wt %) based on impact copolymer weight and with ethylene propylene copolymer rubber present at 3-50 wt % based on impact copolymer weight prepared in-reactor or an impact modifier or random copolymer rubber prepared by copolymerization of two or more alpha olefins prepared in-reactor; PP impact copolymer with either a PP homopolymer or PP random copolymer matrix for 50-97 wt % of the impact copolymer weight and with ethylene-propylene copolymer rubber present at 3-50 wt % of the impact copolymer weight added via compounding, or other rubber (impact modifier) prepared by copolymerization of two or more alpha olefins (such as ethylene-octene) by Zeigler-Natta, metallocene, or single-site catalysis, added via compounding such as but not limited to a twin screw extrusion process. Particularly desirable is PP homopolymer or a random copolymer of propylene (PP-based copolymer) with 0.5-5 percent by weight ethylene.

In one embodiment, all semi-crystalline polymers, preferably all polymers in the filled polymer composition have a weight-averaged molecular weight (Mw) less than one million grams per mole. That is, all semi-crystalline polymers, preferably all polymers in the filled polymer composition are free of a Mw component that exceeds one million grams per mole. Filled polymer compositions are easier to process when the semi-crystalline polymers, preferably all polymers in the filled polymer composition have Mw less than one million grams per mole because when the Mw exceeds one million the viscosity of the polymer composition dramatically increases.

The filler can be a single type of filler or a combination of different fillers. Fillers are generally in a form of powder, flake, fiber, bead, dust or some combination thereof. Suitable fillers include organic and inorganic filler materials. Examples of suitable organic fillers include cellulosic material such as wood fiber, wood flour, wood pulp, flax, ground agricultural wastes such as rice hulls, wheat, oat, barley and oat chaff, nut shells, straw, corn husks and/or stalks, jute, hemp, and bamboo. Organic fillers can be polymeric in nature, such as thermoset polymers or foams, microspheres such as EXPANCEL® microspheres (EXPANCEL is a trademark of Akzo Nobel), highly crosslinked thermoplastic polymers, crosslink rubber, and any other polymer that forms a discrete phase within the filled polymer composition. The filled polymer composition can be free of any one or more of these organic fillers.

Inorganic fillers offer advantages over some organic fillers, particularly cellulosic fillers. Cellulosics can discolor in the sun, take up moisture, and even decompose in the present of moisture. Inorganic fillers, which do not discolor in the sun or decompose in the presence of moisture, are therefore desirable over cellulosic fillers.

Inorganic filler may be reactive or inert. Reactive fillers react with water and include materials such as Portland cement and gypsum. Inert fillers do not react with water. Inert inorganic fillers are desirable for achieving a stable polymer composition density because polymer composition containing the filler density is less likely to change upon exposure to moisture than with a reactive filler. Suitable inert inorganic fillers include talc (including any individual or combination of materials or grades of materials commonly known as and available as “talc”), fly ash, calcium carbonate, clay (for example, kaolin), dolomite, glass beads, silica, aluminum trihydrate, magnesium hydroxide, mica, metal, feldspar, carbon black, nano-fillers, Wollastonite, glass fibers, metal fibers, and boron fibers. Filled polymer compositions can be free of any one or more of these inorganic fillers.

The optimum amount of filler in the polymer composition of the present process depends on target properties for the final oriented polymer composition and the density of filler. Typically, a polymer composition in the present invention contains 0.10 weight-percent (wt %) or more filler and can contain 10 wt % or more, 20 wt % or more, 30 wt % or more, even 40 wt % or more. Filler can be present in an amount of 60 wt % or more, even 70 wt % or more. Generally, the amount of filler is 99 wt % or less. If filler is present at a concentration exceeding 99 wt % the polymer composition tends to undesirably lose structural integrity. Determine wt % of filler based on the weight of filled polymer composition.

Blend the filler and semi-crystalline thermoplastic polymer together at a blending temperature to form a filled polymer composition. The blending temperature is higher than the Tₘ of the thermoplastic polymer. Such a blending temperature is necessary to assure that the semi-crystalline thermoplastic polymer is molten to allow thorough blending of the filler into the semi-crystalline thermoplastic polymer. A heated extruder serves as one example of a suitable mixer for mixing the filler and semi-crystalline thermoplastic polymer. For instance, feed pellets and/or powder of a semi-crystalline thermoplastic polymer and filler into an extruder, simultaneously or independently, and mix them together as the thermoplastic polymer pellets melt. While an extruder serves as an ideal means of blending filler and semi-crystalline thermoplastic polymer, any other method of blending these components at the blending temperature to form a filled polymer composition also falls within the scope of this invention.

The resulting polymer composition has both a melting temperature (Tₘ) and a crystallization temperature (T_{c}). Both Tₘ and T_{c} correspond to a phase change between crystalline and molten states of a filled polymer composition. Nonetheless, for any given polymer composition Tᵣ, is generally higher than the T_{c} when measured using a finite heating and cooling rate by a DSC method. Notably, Tₘ and/or T_{c} of a polymer can be affected by the presence of filler or other polymers. Therefore, polymer compositions may have a Tᵣ, or T_{c} different than a neat polymer in the composition.

After forming a filled polymer composition at a temperature above the filled polymer composition's Tₘ, cool the filled polymer composition to a drawing temperature (T_{d}) and then begin drawing the composition at T_{d} through a drawing die. T_{d} must lie within a special and narrow range of temperatures wherein a polymer composition has some level of relative crystallinity but not so high of a level of relative crystallinity as to result in freeze-up in the drawing die. At T_{d}, the polymer composition has a relative crystallinity of one percent or more and 50% or less, preferably 40% or less, more preferably 20% or less, more preferably 10% or less, still more preferably 5% or less. Still more desirably, T_{d} is also a temperature wherein the polymer composition will undergo strain induced crystallization upon drawing through a drawing die, but not crystallize so extensively as to freeze-up in the drawing die.

It is also important in the practice of the present invention that the polymer composition have a generally uniform temperature profile when entering a drawing die. As a polymer composition enters a drawing die it has a cross section and the temperature at any point on that cross section is ten ° C. or less, preferably 5° C. or less, more preferably one ° C. or less, still more preferably 0.5° C. or less and most preferably zero ° C. from T_{d}.

Experimentation has surprisingly discovered the temperature range suitable for T_{d}. The T_{d} for a polymer composition must be higher than T_{c} for the polymer composition as determined using a similar cooling rate in a DSC as the polymer experiences in the drawing process as the polymer composition approaches and enters the drawing die. At a T_{d} at or below Tₒ, the viscosity of the polymer composition becomes too high to draw without breaking in the drawing die. Preferably, T_{d} is one degree or more above Tₒ. More preferably, T_{d} is five or fewer degrees higher than Tₒ.

The T_{d} for a polymer composition has a high temperature limit that is equal to or higher than the temperature at which crystallization begins to occur when the polymer composition is cooled from above its Tᵣ, down to below its T_{c} at a cooling rate equivalent to the cooling rate the polymer composition experiences as it approaches the drawing die in the drawing process. The high temperature limit is that temperature at which the DSC curve deviates from baseline due to initial crystallization but prior to T_{c} when cooling from above Tₘ to below T_{c} at the same cooling rate as prior to the drawing die. If T_{d} were any higher the polymer composition would experience insufficient crystallization during drawing to induce cavitation. Preferably, the high temperature limit of the temperature range for T_{d} is the highest temperature at which a DSC curve experiences an inflection point between Tₘ and T_{c}.

It is important not to cool the filled polymer composition below T_{c}, preferably not below T_{d} prior to beginning to draw the polymer composition through a drawing die. That way the filled polymer composition remains in a softened state and a state of low crystallinity and relatively low viscosity until drawn. By preserving the softened state and state of low relative crystallinity of the filled polymer composition, the present process can be a continuous process efficiently allowing extrusion of a polymer composition directly from a state of low crystallinity into a cavitated filled oriented polymer article. As a result, the present process avoids requiring one or more of the following: formation of individual polymer billets, storage of billets, going through cooling and subsequent heating steps prior to drawing through a drawing die and/or drawing a highly crystalline polymer (which would require more energy and force than drawing a low crystalline polymer).

The present process offers simplification over other solid state cavitation drawing processes by, for example, requiring less of a “footprint” than conventional solid state drawing processes that require additional handling steps (for example, to accommodate billet cooling and heating prior to drawing or billet storage as is necessary for batch processes).

The present process also offers versatility by allowing collection of one or more than one polymer stream of filled polymer composition (for example, in a reservoir) after being mixed but prior to being drawn through a drawing die. Collection of the polymer stream(s) allows for production of cavitated filled oriented polymer articles having a larger cross section than the cross section of any one stream of filled polymer composition prior to collection. Upon collection the polymer from the stream or streams it can be isothermally conditioned in bulk prior to drawing.

After cooling the filled polymer composition to T_{d}, draw the filled polymer composition through a drawing die at a drawing rate, thereby inducing polymer orientation, cavitation and, typically, crystallization. This step differentiates the present process from the molten state process of U.S. Pat. No. 5,474,722 ('722). In general, '722 requires drawing at a polymer temperature “at or close to” a crystalline polymer composition's Tₘ. In particular, the molten state process of '722 illustrates drawing at or near a polymer composition's softening temperature (Tₘ) using a drawing die that is generally at a temperature 1-10° C., preferably 2-5° C. above the polymer composition's Tₘ. The process of the present invention requires drawing a filled polymer composition at a temperature well below the filled polymer composition's Tₘ using a drawing die that is desirably at a temperature below the polymer composition's Tₘ, hence, T_{d} is not “at or close to” Tₘ for the polymer composition. By drawing at this lower temperature the present process can achieve cavitation in the polymer composition, unlike the molten process in '722. By further contrast, the molten process of '722 requires a foaming agent to introduce void volume to adjust extrudate density. The present invention takes advantage of this carefully selected T_{d} to achieve both strain induced crystallization and cavitation while drawing a filled polymer composition through a drawing die.

The present drawing process surprisingly allows for incorporation of void volume without requiring a foaming agent. In fact, the filled polymer composition of the process of the present invention desirably contains less than three weight-percent (wt %), preferably less than two wt %, still more preferably less than one wt %, even more preferably zero wt % blowing agent based on filled polymer composition weight at any point in the process.

Herein, blowing agent includes carbon dioxide, argon, and nitrogen, water, aliphatic and cyclic hydrocarbons having from one to nine carbons, fully and partially halogenated aliphatic hydrocarbons having from one to five carbons, aliphatic alcohols having from one to five carbons; carbonyl containing compounds, ether containing compounds and carboxylate compounds that have from one to five carbons; and chemical blowing agents such as azodicarbonamide, azodiisobutyronitrile, benzenesulfo-hydrazide, 4,4-oxybenzene sulfonyl semi-carbazide, p-toluene sulfonyl semi-carbazide, barium azodicarboxylate, N,N′-dimethyl-N,N′-dinitrosoterephthalamide, trihydrazino triazine and sodium bicarbonate.

Drawing dies for use in the present invention desirably have a nominal draw ratio greater than 1:1 so as to force a filled polymer composition drawn through the drawing die to reduce in one or more cross sectional dimension and thereby facilitate strain induced crystallization and cavitation in the filled polymer composition. The nominal draw ratio of the drawing die can be 1:3 or more, 1:6 or more, even 1:10 or more but is generally 1:20 or less. Drawing a filled polymer composition through a drawing die having a nominal draw ratio greater than 1:20 at T_{d} can tend to result in fracturing, splintering or breaking of the polymer composition. Concomitantly, it is desirable to use a drawing die that has at least one semi-angle that is greater than one degree otherwise the drawing die tends to be so long that the filled polymer composition crystallizes and freezes within the drawing die.

A drawing die may attach directly to an extruder such that the drawing die's entrance opening directly follows the extruder's mixing element or elements. Alternatively, spacers may exist between the extruder and drawing die. Spacers may be, for example, in the form of coolers through which polymer composition travels, collection zones where polymer composition collects to take a form having a cross section greater than the polymer composition entering the collection zone, or a combination of one or more cooler and one or more collection zone. When using a collection zone prior to drawing, the largest cross section of the reservoir serves as the entrance opening of a subsequent drawing die.

Draw a filled polymer composition through a drawing die by any means. For example, extend a portion of filled polymer composition through the exit opening of a drawing die and apply a drawing force to that portion of filled polymer composition so as to draw the filled polymer away from the drawing die. Any means of applying drawing force is suitable and exemplary means include twin belt drives or rollers mounted on opposing sides of a polymer composition.

Draw the filled polymer composition through the drawing die at a drawing rate. Drawing rate is a linear rate at which polymer composition exits a drawing die. The drawing rate must be greater than zero for there to be a drawing rate. The upper limit on drawing rate is limited only by the tensile strength of the filled polymer composition undergoing drawing. The drawing rate should be less that which requires a drawing force in excess of the filled polymer composition's tensile strength at any point in the drawing die. If the drawing rate exceeds that rate, the filled polymer composition will undesirably experience fractures during the drawing process. The drawing rate is greater than the linear rate at which the filled polymer composition enters the drawing die.

Include a surface lubricant where polymer composition contacts the drawing die in the shaping channel to minimize drawing force by promoting extensional flow through a drawing die. Suitable lubricants include silicone oils, liquid paraffins, glycerin, castor oil fatty amides, titanites and water. Introduce lubricants to the interface typically in a gas or liquid state. Lubricants can also be part of the polymer composition, that is, admixed within the polymer composition. Alternatively, treat the surface of a polymer composition, the drawing die portion that contacts the polymer composition or both with lubricant prior to drawing, while drawing or both.

After drawing, cool the filled polymer composition (now cavitated and oriented) to a temperature below the filled polymer composition's T_{c} to form a cavitated filled oriented polymer article. Such a cooling step preferably occurs promptly upon exiting the drawing die and serves to minimize or reduce die swell and/or free drawing of the drawn filled polymer composition. Desirably, the process is free of die swell in the filled polymer composition, free drawing of the filled polymer composition, or both after the filled polymer composition exits the drawing die. Cooling can occur by any means and may include, for example, spraying with water or cooling through one or more temperature controlled land sections attached to a drawing die.

The present invention is useful for preparing cavitated filled oriented polymer articles of any shape or size, but is particularly useful for preparing such articles having large cross sections. Desirably, the exit opening of the drawing die (and, hence, the cavitated filled oriented polymer article prepared by the present process) has a smallest cross sectional dimension greater than 1.5 millimeters (mm), preferably greater than three mm, still more preferably greater than one centimeter (cm) and can be five cm or more, even ten cm or more.

The exit opening of the drawing die (and, hence, the cavitated filled oriented polymer articles prepared by the present invention) can have cross sectional shape including those having a perimeter that is elliptical, oval, triangle, square, rectangle, pentagon, hexagon, keyhole, arched doorway, hollow, or any other profile useful as trim and/or siding (for example, moldings such as crown moldings, chair rail, window and door trim, and baseboards) or as decking or other structural components (for example, railings, boards, joists, beams, girders, spindles, poles and posts).

The following examples serve to further illustrate specific embodiments of the present invention.

Prepare a filled polymer composition for the present examples by melt blending into polypropylene (a nucleated polypropylene-ethylene random copolymer having 0.5 wt % ethylene component and a melt flow rate of 3; for example, INSPIRE® Performance Polymer D404.1 resin available from The Dow Chemical Company (INSPIRE is a trademark of The Dow Chemical Company)) 60 wt % of a talc filler (for example, TC-100 from Luzenac). The filled polymer composition has a density of 1.52 grams per cubic centimeter (g/cc), a Tₘ of 165° C. and a T_{c} of 139° C. (determine Tₘ using a heating rate of 10° C. per minute and T_{c} using a cooling rate of one ° C. per minute). The filled polymer composition is free from having a weight-averaged molecular weight component that is greater than one million grams per mole.

Use a laboratory scale melt indexer with a conical die to simulate a continuous process in which a filled polymer composition travels directly from being melt blended to being drawn through a drawing die. The conical die has an exit diameter of 6.7 millimeters (0.264 inches) and serves as a drawing die for the present samples. Various conical dies, differing in die semi-angle and all having a nominal draw ratio of 1.6, were used in different examples. Coat the barrel of the melt indexer and conical die with a silicone-based lubricant (for example, silicone-based release agent number 7 from Dow Corning).

Introduce the filled polymer composition into the barrel of the melt indexer and heat to 180-190° C. (a typical extrusion temperature for the filled polymer composition). Heat the filled polymer composition until the polymer is fully melted and the temperature has equilibrated in the filled polymer composition.

Cool the polymer composition in the barrel of the melt indexer at a rate of 1° C. per minute to a drawing temperature (T_{d}) as shown in Table 1. T_{d} is within 1°-5° C. higher than T_{c} for the filled polymer composition. As the filled polymer composition reaches T_{d}, slowly push a portion of the polymer composition through the conical die at a rate of 0.15 millimeter per minute to provide a portion of filled polymer composition that extends through the conical die. When the filled polymer composition reaches T_{d}, apply a drawing force to the filled polymer composition that has gone through the conical die and continue to draw the filled polymer composition through the conical die at a constant rate of 18-20 centimeters (7-8 inches) per minute.

Upon entering the conical die the polymer composition has a relative crystallinity of in a range of one percent to twenty percent relative crystallinity, inclusive of endpoints and has a temperature difference at any two points on the polymer composition's cross section that is less than one degree Celsius.

Upon exiting the conical die the filled polymer composition air cools to a temperature below the filled polymer composition's T_{c} to form a cavitated, filled, oriented polymer composition having a smallest cross sectional dimension (in this case, a cross sectional diameter) of about 6.7 millimeters (0.264 inches). The polymer composition cools without experiencing die swell or free drawing after exiting the drawing die. Cavitation is evident by a reduction in density in the filled polymer composition after drawing. Orientation is evident by an increase in flexural modulus.

Table 1 presents the conical die semi-angle, drawing temperature and resulting density information for the present examples.

TABLE 1

| | Die Semi- | T_{d} | Final Density | % Density |
|---|---|---|---|---|
| Example | Angle | (° C.) | (g/cc) | Reduction |
| 1 | 9 | 140 | 1.27 | 16 |
| 2 | 15 | 140 | 1.19 | 22 |
| 3 | 30 | 140 | 1.18 | 22 |
| 4 | 40 | 140 | 0.939 | 38 |
| 5 | 2 | 141 | 0.697 | 54 |
| 6 | 5 | 141 | 1.16 | 24 |
| 7 | 9 | 141 | 1.08 | 29 |
| 8 | 15 | 141 | 1.28 | 16 |
| 9 | 30 | 141 | 1.11 | 27 |
| 10 | 40 | 141 | 0.95 | 37 |
| 11 | 2 | 142 | 0.790 | 48 |
| 12 | 9 | 142 | 1.20 | 21 |
| 13 | 30 | 142 | 1.16 | 24 |
| 14 | 40 | 142 | 0.813 | 46 |
| 15 | 2 | 143 | 0.941 | 38 |

Examples 1-15 illustrate processes that produce cavitated and filled polymer compositions by drawing a polymer composition from a state of low crystallinity at various drawing temperatures ranging from 1-5° C. above the filled polymer composition's T_{c} and using drawing dies with various semi-angles and nominal draw ratios. Similar results are expected from similar filled polymer compositions that proceed directly from being melt blended to being drawn through a similar drawing die without first being cooled below the filled polymer composition's T_{c}.

1. A process for producing a filled oriented polymer article comprising the steps:
(a) blending at least one semi-crystalline thermoplastic polymer with a filler at a blending temperature to form a filled polymer composition having a melting temperature (Tₘ) and a crystallization temperature (T_{c});
(b) cooling the filled polymer composition at a cooling rate to a drawing temperature (T_{d}) without cooling below the filled polymer composition's T_{c};
(c) drawing the filled polymer composition through a drawing die at a drawing rate, thereby inducing polymer orientation and cavitation; and
(d) cooling the filled polymer composition to a temperature below its T_{c} to form a cavitated filled oriented polymer article;
wherein, the blending temperature is at or above the filled polymer composition's Tₘ, T_{d} is higher than the filled polymer composition's T_{c} yet lower than the temperature at which crystallization begins to occur as the filled polymer composition is cooled from above its Tₘ down to below its T_{c} at the cooling rate of step (b), and drawing in step (c) is initiated while the polymer composition has a relative crystallinity of 50% or less and one percent or more and while the polymer composition has a cross section that has a temperature at any point on the cross section within ten degrees Celsius from T_{d}.

2. The process of claim 1, wherein T_{d} is one to five degrees Celsius above T_{c} for the filled polymer composition.

3. The process of claim 1, wherein the drawing die in step (c) has a nominal draw ratio greater than 1:1.

4. The process of claim 1, wherein the drawing die has at least one semi-angle greater than one degree.

5. The process of claim 1, wherein the semi-crystalline thermoplastic polymer is one or a blend of more than one polymer selected from a group consisting of polymers based on polyethylene, polypropylene, polyvinyl chloride and polyester polymers.

6. The process of claim 1, wherein all polymers in the filled polymer composition have a weight-averaged molecular weight of less than one million grams per mole.

7. The process of claim 1, wherein blowing agents are present at a concentration of less than three weight-percent based on total weight of filled polymer composition.

8. The process of claim 1, wherein the filled polymer composition in step (c) is free of blowing agents.

9. The process of claim 1, wherein the drawing die has an exit opening having a smallest cross sectional dimension greater than 1.5 millimeters.

10. The process of claim 1, wherein drawing in step (c) is initiated while the polymer composition has a relative crystallinity of one percent or more and 20 percent or less.

11. The process of claim 1, wherein drawing in step (c) is initiated while the polymer composition has a relative crystallinity of one percent or more and ten percent or less.

12. The process of claim 1, wherein all semi-crystalline polymers in the filled polymer composition are free from having a weight-averaged molecular weight component that is greater than one million grams per mole.
